(19) United States
(12) Patent Application Publication
(10) Pub. No.: US 2023/0316385 A1
(43) Pub. Date: Oct. 5, 2023

(54) TARGET ARTICLE PLACE SEARCH SYSTEM AND COMPUTER PROGRAM PRODUCT

(71) Applicant: KATSUNORI SUETSUGU, Tokyo (JP)

(72) Inventor: KATSUNORI SUETSUGU, Tokyo (JP)

(21) Appl. No.: 18/155,563

(22) Filed: Jan. 17, 2023

(30) Foreign Application Priority Data
Mar. 10, 2022 (JP) 2022-037388

(51) Int. Cl. G06Q 30/0601

(52) U.S. Cl. CPC G06Q 30/0639

(57) ABSTRACT

A target article place search system includes an article information storage unit configured to store article information that is information on articles in a target area, an article place storage unit configured to store article place information indicating places in which the articles are present, a search request receiving unit configured to receive a request to search for the target article in the target area made by the user, a target article determination unit configured to determine an article corresponding to the target article by searching the article information, an article place determination unit configured to determine a place in which the article corresponding to the target article determined by the target article determination unit is present on the basis of the article place information stored in the article place storage unit, and an article place notification unit configured to notify the user of the place.

### TECHNICAL FIELD

The present invention relates to a target article place search system and computer program product for searching for a target article present in a target area.

### BACKGROUND ART

While users who purchase products at EC sites on the Internet have increased in recent years, there are a large number of real stores on the streets.

Conventionally, a user who visits a real store having a wide selection of products to purchase a target product has difficulty in finding the target product. In this case, the user gives up finding the product, or takes time to find it, or finds it by asking a salesclerk. Similarly, a worker takes time in finding a target article in a warehouse or office.

To solve such a problem, Japanese Patent No. 5150018 describes a technology that displays, on a monitor, a screen that allows a user to visually identify the storage places of documents and turns on lamps mounted on the storage places in different colors or blinks them in accordance with purposes such as a search.

See Japanese Patent Publication No. 5150018.

### SUMMARY OF INVENTION

However, the technology described in Japanese Patent No. 5150018 is a technology specialized in searching for a document. While it is suitable for a user to accurately search for a desired document, it is difficult to use for general purposes. There are not only a need to search for a document, but also a need to search for a target product in a real store, a need to reach the storage place of a target product in a warehouse and carry out the product, and a need to know the place in which a previously purchased article is stored in a home.

The present invention has been made in view of the above problems, and an object thereof is to provide a target article place search system and computer program product capable of searching for the place in which a target article desired by a user is present in a target area such as a real store, warehouse, office, home, or the like.

To accomplish the above object, a target article place search system according to a first aspect of the present invention is a target article place search system for searching for a target article desired by a user from among articles present in a target area. The target article place search system includes an article information storage unit configured to store article information that is information on the articles present in the target area, an article place storage unit configured to store article place information indicating places in which the articles are present in the target area, a search request receiving unit configured to receive a request to search for the target article in the target area made by the user, a target article determination unit configured to, when the search request receiving unit receives the search request, determine an article corresponding to the target article by searching the article information stored in the article information storage unit, an article place determination unit configured to determine a place in which the article corresponding to the target article determined by the target article determination unit is present on the basis of the article place information stored in the article place storage unit, and an article place notification unit configured to notify the user of the place in which the article corresponding to the target article is present determined by the article place determination unit.

A target article place search system according to a second aspect of the present invention is a target article place search system for searching for a target article desired by a user from among articles present in a target area. The target article place search system includes a target area setting unit configured to set one or more target areas selectable by the user as a search target in accordance with a setting input operation performed by the user, an article information storage unit configured to store article information that is information on the articles present in the target area, an article place storage unit configured to store article place information indicating places in which the articles are present in the target area, a search request receiving unit configured to, when the user selects a target area from among the one or more target areas set by the target area setting unit and inputs a target article to be searched for in the selected target, receives a request to search for the target article in the target area, a target article determination unit configured to, when the search request receiving unit receives the search request, determine an article corresponding to the target article by searching the article information stored in the article information storage unit, an article place determination unit configured to determine a place in which the article corresponding to the target article determined by the target article determination unit is present on the basis of the article place information stored in the article place storage unit, and an article place notification unit configured to notify the user of the place in which the article corresponding to the target article is present determined by the article place determination unit.

The present invention is able to search for the place in which the target article desired by the user is present in the target area such as a real store, warehouse, office, or home.

The target article place search system according to the first aspect of the present invention may further include a candidate presentation unit configured to, when the target article determination unit fails to determine an article corresponding to the target article, present a list of candidates for an article corresponding to the target article to the user on the basis of the article information stored in the article information storage unit. When a particular article is selected from the list of candidates presented to the user by the candidate presentation unit, the target article determination unit may determine that the particular article is an article corresponding to the target article.

According to the first aspect of the present invention, the user is able to select the particular article from the list of candidates. Thus, even if the target article determination unit fails to determine an article corresponding to the target article, it determines that the particular article selected by the user is an article corresponding to the target article and performs a process. For this reason, the process can be performed smoothly. Also, even if there is no article corresponding to the target article in the list of candidate articles, the user is able to select an alternative article from the list of candidates.

In the target article place search system according to the first aspect of the present invention, the request to search for the target article may include a candidate request flag indicating whether a list of candidates for an article corresponding to the target article is requested. If the candidate request flag indicates that a list of candidates is requested, the candidate presentation unit may present a list of candidates for an article corresponding to the target article to the user on the basis of the article information stored in the article information storage unit.

According to the first aspect of the present invention, for example, if the user wants to select a product to be purchased from among a predetermined type of products in a real store, the user is able to receive presentation of a list of candidates.

The target article place search system according to the first aspect of the present invention may further include a sketch storage unit configured to store sketch information indicating a sketch of the target area and a route determination unit configured to determine the shortest route from a place in which the user is present to the place in which the article corresponding to the target article is present determined by the article place determination unit on the sketch on the basis of the sketch information stored in the sketch storage unit. The article place notification unit may notify the user of the shortest route determined by the route determination unit.

According to the first aspect of the present invention, the user is able to reach the place in which the article corresponding to the target article is present from the place in which the user is present through the shortest route.

In the target article place search system according to the first aspect of the present invention, lamps may be mounted on a floor of the target area, and the article place notification unit may turn on or blink a lamp present on the shortest route.

According to the first aspect of the present invention, the user is able to reach the place in which the article corresponding to the target article is present without getting lost by advancing along the turned-on or blinking light.

In the target article place search system according to the first aspect of the present invention, the request to search for the target article may be a request to search for an article having a predetermined sales ranking in a predetermined period of time and a predetermined population.

According to the first aspect of the present invention, the user is able to search for the article having the predetermined sales ranking.

A computer program product according to a third aspect of the present invention is a computer program product for searching for a target article desired by a user from among articles present in a target area. The computer program product causes a computer to function as article information storage means configured to store article information that is information on the articles present in the target area, article place storage means configured to store article place information indicating places in which the articles are present in the target area, search request receiving means configured to receive a request to search for the target article in the target area made by the user, target article determination means configured to, when the search request receiving means receives the search request, determine an article corresponding to the target article by searching the article information stored in the article information storage means, article place determination means configured to determine a place in which the article corresponding to the target article determined by the target article determination means is present on the basis of the article place information stored in the article place storage means, and article place notification means configured to notify the user of the place in which the article corresponding to the target article is present determined by the article place determination means.

The present invention is able to search for the place in which the target article desired by the user is present in the target area such as a real store, warehouse, office, or home.

### BRIEF DESCRIPTION OF DRAWINGS

FIG. 1 is a diagram showing the overall configuration of a target article place search system according to an embodiment of the present invention;

FIG. 2 is a diagram showing the functional elements of a server included in the target article place search system according to the present embodiment; and

FIG. 3 is a flowchart showing the steps of a search process performed by the target article place search system according to the present embodiment.

### DESCRIPTION OF EMBODIMENTS

Now, an embodiment of the present invention will be described in detail with reference to the drawings.

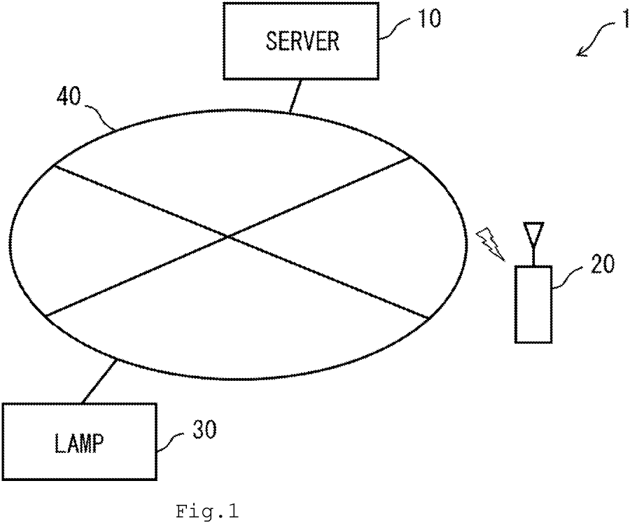

FIG. 1 is a diagram showing the overall configuration of a target article place search system 1 according to the embodiment of the present invention. As shown in FIG. 1, the target article place search system 1 includes a server 10 that controls the search for a target article present in a target area, an information communication terminal 20 used by a user to search for the target article present in the target area, lamps 30 placed on passages, product display shelves, or the like in one or more target areas, and a communication network 40, such as the internet or mobile communication network, through which the devices 10, 20, and 30 are communicatively connected to each other.

The information communication terminal 20 is a communication-capable computer used by the user to search for the target article present in the target area and is, for example, a smartphone. The information communication terminal 20 is not limited to a smartphone and only has to be a device that is able to input, receive and transmit text data such as a keyword or data such as voice or image and has a GPS function of acquiring location information so that the user can search for the target article. For example, it may be a tablet device, a PC terminal, a wearable terminal like a watch, or a neck-hanging hands-free terminal.

As used herein, the “target area” refers to an area in which multiple articles such as products are placed or stored, such as a real store, warehouse, office, library, or home. Multiple target areas may be set in accordance with the user’s needs.

The server 10 includes, as hardware, a CPU, memory such as RAM, ROM, and hard disk, and a communication interface that controls communication through the communication network 40. The memory of the server 10 is storing software such as various types of data, databases and programs. Examples of the data stored in the memory of the server 10 include the name(s) of the target area(s), information on the location(s) of the target area(s), information on a sketch(es) of the target area(s), information on articles placed in the target area(s) (article information), and information on lamps, speakers, or the like placed near the articles.

The sketch information includes information in which the names of places present in the target area(s) and information on the locations of the places are associated with each other. The three-dimensional shape of a target area can be recognized and displayed on the basis of the sketch information. These types of information may be inputted to the server 10 by the user, or information inputted to and managed by another system may be downloaded to the server 10.

Examples of the programs stored in the memory of the server 10 include a program for analyzing a request to search for the target article received from the information communication terminal 20, a program for determining the place in which the target article is present in the target area, a program for notifying the user of the place in which the target article is present, a program for controlling turn-on or blink of a lamp 30 by transmitting an turn-on instruction or blink instruction to the lamp 30, and the like.

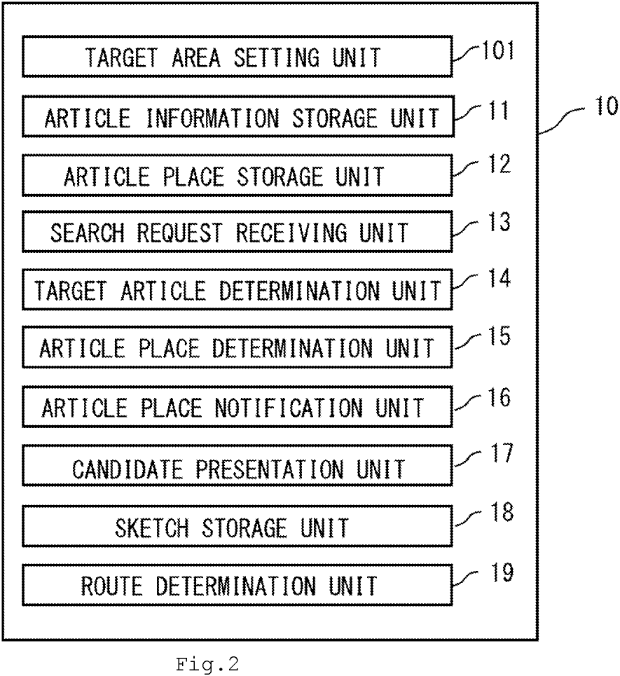

When the CPU of the server 10 performs processing in accordance with software stored in the memory, functional elements shown in FIG. 2 are implemented in the server 10.

A target area setting unit 101 stores one or more target areas selectable by the user as a search target in the database in accordance with a setting input operation performed by the user.

An article information storage unit 11 stores various types of information on articles present in the target area(s) (hereafter referred to as the “article information”) in the database. The “article information” includes the name of the articles, the target area(s) in which the articles are placed, the types or categories of the articles, information on the places in which the articles are placed, information on sales if the articles are products, and the like. The “information on the places in which the articles are placed” includes the name(s) of the target area(s) to which the places belong (the name(s) of store(s), warehouse(s), or the like), the names of the places (shelves, drawers, or the like), information on the locations of the places, and the like.

If the article is a product to be sold in a real store, a salesclerk may input article information on the product through the information communication terminal 20 when storing the product in a warehouse or displaying the product.

If the article is an article to be stored or displayed in the user’s home, the user may input article information on the article through the information communication terminal 20 when storing or displaying it in a predetermined place in the home.

An article place storage unit 12 stores, in the database, article place information indicating the places in which the articles are present in the target area(s). For example, when the user inputs information on a particular article by operating the information communication terminal 20, the article place storage unit 12 acquires the location information from the GPS of the information communication terminal 20 and stores it as place information of the article.

If the information on the article inputted by the user includes the name of the place (for example, a shelf in a conference room in the second floor, a living room, or the like) in which the article is stored, the article place storage unit 12 acquires location information corresponding to the name of the place by checking the name of the place against the sketch information and stores the location information as information on the place in which the article is present.

A sketch storage unit 18 stores sketch information indicating a sketch(es) of the target area(s) in the database.

A search request receiving unit 13 receives the request to search for the target article made by the user from the information communication terminal 20. For example, when the user selects one target area from among the one or more target areas set by the target area setting unit 101 and inputs a request to search for a target article, the search request receiving unit 13 receives the target article search request from the information communication terminal 20.

In the present embodiment, the target article search request includes information on the specification of a search method, information on the specification of a search target, and a “candidate request flag.”

The search method specification information includes information indicating the specification of a keyword search using text, a similarity search, a fuzzy search, a search using AI, a search using image data rendered by the user, a search using image data, text data, or the like selected from multiple candidates, a search using voice, or a combination of these search methods.

When performing a search using an image, image data rendered by the user by operating the information communication terminal 20 may be received from the information communication terminal 20.

If the “target area” is a real store, examples of the information on the specification of the search target include the specification of a search for sundries of 500 yen or less, such as “sundries AND 500 yen or less.” If the “target area” is a warehouse, examples include the specification of a search for products delivered this year or a product A, such as “products delivered this year OR a product A,” and the specification such as “other than products delivered this year.” If the “target area” is an office, examples include the specification of a search for a product using a product model number, such as “product number 2022-A.” Examples also include the specification of a search for products having predetermined sales rankings in a predetermined period of time and a predetermined population, such as “products having the first to third highest sales rankings among shirts sold at a real store last month.”

The “candidate request flag” is a flag indicating whether the user requests a list of candidates for an article corresponding to the target article. If the “candidate request flag” is set to ON, it indicates that the user requests a list of candidates. In this case, candidate list information for displaying a list of candidates for an article corresponding to the target article is generated on the basis of the article information stored in the article information storage unit 11.

A target article determination unit 14 determines an article corresponding to the target article by searching the article information stored in the article information storage unit 11 on the basis of the information on the specification of the search method included in the target article search request received by the search request receiving unit 13.

If the target article determination unit 14 fails to determine an article corresponding to the target article as a result of the search of the article information, or if the “candidate request flag” included in the target article search request is set to ON, or if the “candidate request flag” is set to OFF but the target article determination unit 14 determines that it is preferable to present candidates to the user, the target article determination unit 14 instructs a candidate presentation unit 17 to present a list of candidates to the user.

Conceivable cases in which the target article determination unit 14 fails to determine an article corresponding to the target article include a case in which a keyword search shows that there is no exactly matching article name in the article information storage unit 11, a case in which a fuzzy search shows that similarity falls outside a predetermined range, a case in which there are a predetermined number or more of articles corresponding to the target article, and the like.

A known technology may be used as the database forming the article information storage unit 11 or the search method. For example, the database may be an SQL relation database, or NoSQL used in big data. The search method may be character input, voice input, an expectation search based on the history or attributes of an individual using AI, or a fuzzy search.

If the target article determination unit 14 determines an article corresponding to the target article, an article place determination unit 15 determines the place in which the article corresponding to the target article is present by searching the article place information stored in the article place storage unit 12.

A route determination unit 19 determines the shortest route from the place in which the user is present to the place in which the article corresponding to the target article determined by the target article determination unit 14 is present on a sketch on the basis of the sketch information stored in the sketch storage unit 18.

The route determination unit 19 may determine the shortest route from the place in which the user is present to the target article only when the user is present in the target area. Or the route determination unit 19 may determine the shortest route from the place in which the user is present or a specified place in the target area to the place in which the article corresponding to the target article is present only when the target article search request includes a request to present the shortest route.

An article place notification unit 16 notifies the user of the place in which the article corresponding to the target article is present determined by the article place determination unit 15.

One method for notifying the user is to transmit voice, image, text data, or the like for notifying the user of the place in which the article corresponding to the target article is present to the information communication terminal 20 that has transmitted the target article search request. There is also a notification method including determining a lamp 30 located in a position nearest to the place in which the article is present on the basis of the sketch information and transmitting a turn-on instruction or blink instruction to the lamp 30 to turn on or blink the lamp 30. For example, in the case of a real store in which products are sold, multiple lamps 30 are previously mounted on product display shelves, and the products are placed near the lamps 30. Thus, a user can easily recognize a product near a turned-on or blinking lamp 30 as a target product.

When the route determination unit 19 determines the shortest route, the article place notification unit 16 transmits an instruction to a lamp 30 on the shortest route to turn on or blink the lamp 30. Or the article place notification unit 16 displays an image showing the place in which the target article is placed or the shortest route on a sketch of the target area on the display of the information communication terminal 20. The article place notification unit 16 may notify the user of the place or shortest route using AR, VR, MR, hologram, or the like.

Instead of or in addition to the lamps 30, speakers or motor-driven objects may be placed in the same positions as those of the lamps 30 so that the user is notified by outputting a sound from a speaker or moving a motor-driven object.

A specific example of the method for notifying the user will be described below.

For example, a lamp 30 mounted on a sign may be turned on or a three-dimensional shaped object (for example, a shaped object in the shape of a PET bottle for mineral water in a case where “mineral water” is searched for as a target article) may be rotated so that the user is notified that the target article is present near the sign or three-dimensional shaped object. Also, when “water” is search for, a sound of running water may be emitted so that the user is notified that “water” is present near the sound of running water.

When the user selects a real store as a target area and inputs “sundries AND 500 yen or less” as a search keyword, the article place notification unit 16 issues a turn-on instruction to a lamp 30 placed near a shelf on which products having a selling price of 500 yen or less among products registered as a product category of sundries in the article information storage unit 11 are displayed in the real store, to turn on the lamp 30. Also, when the user selects a warehouse as a target area and inputs “products delivered this year OR a product A” as a search keyword, the user is notified of the place in which products delivered to the warehouse this year or the product A are stored and a direction toward the place.

Also, when the user selects an office as a target area and inputs “product model number 2022-A” as a search keyword, the user is notified of the place in which an article having “product model number 2022-A” is placed in the office and a direction toward the place.

Also, when the user selects a warehouse as a target area and inputs “other than this year” as a search keyword, the user is notified of the place in which products other than products delivered to the warehouse this year are stored and a direction toward the place.

Also, when the user performs a keyword search in a real store by inputting “water” as text to the information communication terminal 20, the area in which “water” is sold in the real store, the café area in which “water” is supplied, the rest room area in which a water supply for running water is installed, and the like are displayed on the information communication terminal 20. Note that the user may perform a search by rendering “water in a cup” or “water drops” on the display of the information communication terminal 20.

If images of products such as “water,” “bread,” and “apple” displayed in a real store A are previously registered in the article information storage unit 11, the user may perform a search by inputting “products in the real store A” as a target article search request. In this case, if a large number of products correspond to this search request, the candidate presentation unit 17 (to be discussed later) displays the registered images of these products on the information communication terminal 20 as options. If the user selects an image of “water” from among the displayed images, the article place notification unit 16 may notify the user of the place in which a product indicated by the image is present.

If the target article search request received from the information communication terminal 20 by the server 10 is a request to search for products having predetermined sales rankings in a predetermined period of time and a predetermined population, the article place notification unit 16 may notify the user of multiple places, for example, by simultaneously turning on lamps 30 in multiple locations. Also, different notification methods may be used to distinguish the places to be notified from each other. Specifically, if the user searches for products having the first to third highest sales rankings this month in a warehouse, the article place notification unit 16 simultaneously turns on lamps 30 placed near three places in which the products having the first to third highest sales rankings this year are stored. In this case, the article place notification unit 16 may notify the user by turning on the lamps 30 in different colors based on the rankings, for example, by turning on the lamps 30 placed near the places in which the products having the first to third highest sales rankings are stored in red, blue, and green, respectively. An electronic bulletin board may be installed in place of the lamps 30 so that, for example, the first to third highest rankings may be displayed using images or characters on the electronic bulletin board.

If the target article determination unit 14 fails to determine an article corresponding to the target article, or if the “candidate request flag” is ON, or if the “candidate request flag” is OFF but the target article determination unit 14 determines that there is a need to present candidates to the user, the candidate presentation unit 17 generates candidate list information for displaying a list of candidates for an article corresponding to the target article on the basis of the article information stored in the article information storage unit 11 and transmits the candidate list information to the information communication terminal 20 so that the list of candidates is presented to the user.

When the user selects a particular article from the list of candidates presented to the user by the candidate presentation unit 17, the target article determination unit 14 determines that the selected particular article is an article corresponding to the target article and performs a process. Here, the user may be allowed to select only one or multiple articles. If the user is allowed to select multiple articles, an upper limit may be set on the number of articles to be selected.

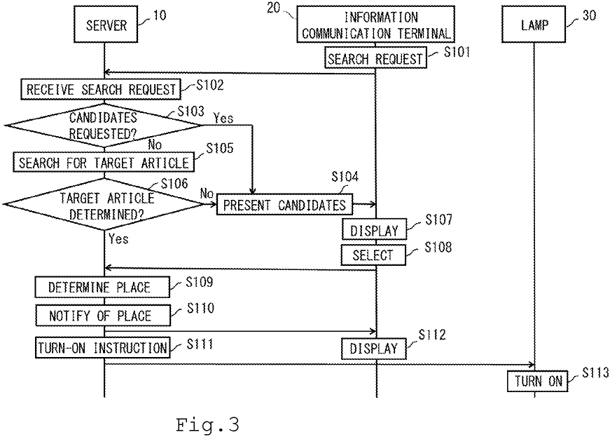

Next, referring to a flowchart shown in FIG. 3, the steps of a search process performed by the target article place search system 1 having the above configuration will be described.

Here, it is assumed that one or more target areas selectable as a search target are previously set by the target area setting unit 101 on the basis of a setting input operation performed by the user. It is also assumed that the article information that is information on the articles placed in the target area(s), the place information indicating the places in which the articles are present, and the sketch information indicating a sketch(es) of the target area(s) are previously registered in the article information storage unit 11, article place storage unit 12, and sketch storage unit 18, respectively.

By operating the information communication terminal 20, the user selects a target area (a real store, warehouse, office, home, or the like), inputs a search keyword as information on the specification of a search target, sets a candidate request flag, and makes an instruction to transmit a target article search request. The information communication terminal 20 transmits the target article search request to the server 10 (step S101).

The search request receiving unit 13 of the server 10 receives the target article search request from the information communication terminal 20 (step S102) and analyzes the target article search request. If the candidate request flag included in the search request is set to OFF (step S103: No), the target article determination unit 14 searches the article information stored in the article information storage unit 11 to determine an article corresponding to the target article (step S105).

If the target article determination unit 14 determines an article corresponding to the target article (step S106: Yes), the article place determination unit 15 determines the place in which the article corresponding to the target article is present in the target area by searching the article place information stored in the article place storage unit 12 (step S109). Note that if the place in which the user is present is known by, for example, acquiring information from the GPS of the information communication terminal 20, the route determination unit 19 of the server 10 may determine the shortest route from the place in which the user is present to the place in which the article is present determined by the article place determination unit 15 on a sketch.

If the target article determination unit 14 fails to determine an article corresponding to the target article (step S106: No), or if it is determined in step S103 that the candidate request flag included in the target article search request is set to ON (step S103: Yes), the candidate presentation unit 17 generates candidate list information indicating a list of candidates for an article corresponding to the target article on the basis of the article information stored in the article information storage unit 11 and transmits the candidate list information to the information communication terminal 20 (step S104).

The information communication terminal 20 receives the candidate list information and displays the list of candidates on the display (step S107). The user selects an particular article from the list of candidates displayed on the display of the information communication terminal 20. The information communication terminal 20 transmits information on the selected article (step S108).

The server 10 receives this information from the information communication terminal 20, determines that the selected article is an article corresponding to the target article, and determines the place in which the article corresponding to the target article is present (step S109). The article place notification unit 16 notifies the user of the place in which the article corresponding to the target article is present determined by the article place determination unit 15 (step S110).

Specifically, the article place notification unit 16 transmits notification information for notifying the user of the place in which the article is placed to the display of the information communication terminal 20. Note that if the route determination unit 19 determines the shortest route, the article place notification unit 16 incorporate information indicating the shortest route into the notification information.

If a lamp 30 is placed near the article, the article place notification unit 16 makes a turn-on instruction to the lamp 30 (step S111). If the shortest route to the article is determined, the article place notification unit 16 transmits a turn-on instruction to a lamp 30 present on the shortest route.

The information communication terminal 20 receives the notification information from the server 10 and displays the notification information on the display (step S112).

The lamp 30 receives the turn-on instruction from the server 10 and turns on (step S113).

As described above, the target article place search system 1 determines the place in which the target article desired by the user is present in the target area such as a real store, warehouse, office, or home and the shortest route from the place in which the user is present to the target article and notifies the user of the place and shortest route. Thus, the user is able to easily know the place in which the target article is present and the shortest route and to efficiently acquire the target article and do work without having to spend time for search uselessly.

The above embodiment is illustrative only, and the present invention can also be carried out by making various modifications to the embodiment without departing from the spirit and scope of the invention as set forth in the claims.

For example, the method for notifying the user of the actual place of the target article or the shortest route may be to notify the user using a symbol indicating the direction such as an arrow, or characters in place of notifying the user by turning on or blinking a lamp 30. The notification method may also be a notification using a sound or a movement such as rotation of an object, or may be any notification method such as display of a hologram, AR, VR, MR, or screen.

Also, the user may be allowed to previously input selection as to whether the user will be notified of both or one of the places of the target article and the shortest route. Also, as the method for notifying the user of the place of the target article, the user may be allowed to previously input selection as to whether the user will be notified by only transmitting a notification to the information communication terminal 20, only turning on a lamp 30 in the actual place, or performing both.

While, in the above embodiment, the communication system of the target article place search system 1 has been described as a client-server system, this is not limiting. The communication system may be, for example, blockchain communication, pier-to-pier (P2P) communication, communication using a distributed storage blockchain, a combination thereof, or a communication system to be developed in the future.

The target article place search system 1 may consist of a single device rather than multiple devices. If the target article place search system 1 consists of a single device, this device may be a stand-alone device, which is not connected to the communication network 40 such as the Internet.

The present invention can be used to search for a displayed product, an in-stock product, a product bought for future use, a document, or the like in a real store, warehouse, office, home, or the like.

If the target area is a store, the present invention can be applied to any of products displayed for consumers and products placed in the backyard as stocks.

If the target area is a warehouse, the present invention is able to display an image of a route to a target product on the information communication terminal 20, to notify the user using a lamp 30 placed on the route, to display an image of a shelf storing the product or the area in which the shelf is placed, on the information communication terminal 20, or to notify the user by turning on a lamp 30 placed in the area in which the shelf is placed.

If the target area is a library, the present invention is able to notify the user by turning on a lamp 30 mounted on a bookshelf on which a book desired by the user is placed. If the target area is the user’s home, the present invention is able to notify the user by displaying a route to the room in which a target article is placed, or the place in which the target article is stored. If the target area is an office and the user searches for a book by performing a keyword search using the information communication terminal 20, the present invention is able to notify the user of information on the place in which the book is stored by displaying the information on the information communication terminal 20 and allows the user to easily find the desired book.

What is claimed is:

1. A target article place search system for searching for a target article desired by a user from among articles present in a target area, comprising:
an article information storage unit configured to store article information that is information on the articles present in the target area;
an article place storage unit configured to store article place information indicating places in which the articles are present in the target area;
a search request receiving unit configured to receive a request to search for the target article in the target area made by the user;
a target article determination unit configured to, when the search request receiving unit receives the search request, determine an article corresponding to the target article by searching the article information stored in the article information storage unit;
an article place determination unit configured to determine a place in which the article corresponding to the target article determined by the target article determination unit is present on the basis of the article place information stored in the article place storage unit; and
an article place notification unit configured to notify the user of the place in which the article corresponding to the target article is present determined by the article place determination unit.

2. The target article place search system of claim 1, further comprising a candidate presentation unit configured to, when the target article determination unit fails to determine an article corresponding to the target article, present a list of candidates for an article corresponding to the target article to the user on the basis of the article information stored in the article information storage unit, wherein
when a particular article is selected from the list of candidates presented to the user by the candidate presentation unit, the target article determination unit determines that the particular article is an article corresponding to the target article.

3. The target article place search system of claim 2,
wherein the request to search for the target article includes a candidate request flag indicating whether a list of candidates for an article corresponding to the target article is requested, and
if the candidate request flag indicates that a list of candidates is requested, the candidate presentation unit presents a list of candidates for an article corresponding to the target article to the user on the basis of the article information stored in the article information storage unit.

4. The target article place search system of claim 1, further comprising:
a sketch storage unit configured to store sketch information indicating a sketch of the target area; and
a route determination unit configured to determine the shortest route from a place in which the user is present to the place in which the article corresponding to the target article is present determined by the article place determination unit on the sketch on the basis of the sketch information stored in the sketch storage unit, wherein
the article place notification unit notifies the user of the shortest route determined by the route determination unit.

5. The target article place search system of claim 4,
wherein lamps are mounted on a floor of the target area, and
wherein the article place notification unit turns on or blinks a lamp present on the shortest route.

6. The target article place search system of claim 1, wherein the request to search for the target article is a request to search for an article having a predetermined sales ranking in a predetermined period of time and a predetermined population.

7. A target article place search system for searching for a target article desired by a user from among articles present in a target area, comprising:
a target area setting unit configured to set one or more target areas selectable by the user in accordance with a setting input operation performed by the user;
an article information storage unit configured to store article information that is information on the articles present in the one or more target areas;
an article place storage unit configured to store article place information indicating places in which the articles are present in the one or more target areas;
a search request receiving unit configured to, when the user selects a target area from among the one or more target areas set by the target area setting unit and inputs a target article to be searched for in the selected target, receives a request to search for the target article in the target area;
a target article determination unit configured to, when the search request receiving unit receives the search request, determine an article corresponding to the target article by searching the article information stored in the article information storage unit;
an article place determination unit configured to determine a place in which the article corresponding to the target article determined by the target article determination unit is present on the basis of the article place information stored in the article place storage unit; and
an article place notification unit configured to notify the user of the place in which the article corresponding to the target article is present determined by the article place determination unit.

8. A computer program product for searching for a target article desired by a user from among articles present in a target area, the computer program product causing a computer to function as:
article information storage means configured to store article information that is information on the articles present in the target area;
article place storage means configured to store article place information indicating places in which the articles are present in the target area;
search request receiving means configured to receive a request to search for the target article in the target area made by the user;
target article determination means configured to, when the search request receiving means receives the search request, determine an article corresponding to the target article by searching the article information stored in the article information storage means;
article place determination means configured to determine a place in which the article corresponding to the target article determined by the target article determination means is present on the basis of the article place information stored in the article place storage means; and
article place notification means configured to notify the user of the place in which the article corresponding to the target article is present determined by the article place determination means.
